(19) United States
(12) Patent Application Publication
(10) Pub. No.: US 2020/0086723 A1
(43) Pub. Date: Mar. 19, 2020

(54) OPTIMIZED MIDDLE RAIN CHANNEL

(71) Applicant: AISIN TECHNICAL CENTER OF AMERICA, INC., Northville, MI (US)

(72) Inventors: Micah WEDEKIND, Livonia, MI (US); Michael MIXON, Brighton, MI (US)

(73) Assignee: AISIN TECHNICAL CENTER OF AMERICA, INC., Northville, MI (US)

(21) Appl. No.: 16/132,723

(22) Filed: Sep. 17, 2018

(51) Int. Cl. B60J 7/00; B60J 7/043; B60J 7/02

(52) U.S. Cl. CPC B60J 7/0084; B60J 7/022; B60J 7/043

(57) ABSTRACT

A sunroof apparatus for an automotive vehicle includes at least one fixed glass panel having an outer rim, at least one movable glass panel having an outer rim, and an area between the outer of the movable glass panel in the width direction of the vehicle and the fixed panel that includes a rain channel. The sunroof apparatus covers a majority of the rain channel with the fixed panel to reduce the rate of water flow into the rain channel

### BACKGROUND

### Field of the Disclosure

The present disclosure is directed towards a middle rain channel for a vehicle sunroof

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Automotive vehicles may be provided with a sunroof or moonroof in the roof of the passenger compartment. A sunroof or moonroof assembly may include a glass panel in a window assembly. In the case of a sunroof assembly, an opening mechanism may also be included. The glass panel may include a movable glass panel and a fixed glass panel, or may include just a movable glass panel. The movable glass panel opens and closes a substantially rectangular opening defined by a periphery of a housing. The housing is mounted to an opening in the vehicle roof. A rain channel may be provided between the movable glass panel and the fixed glass panel to prevent rain from entering in the area between the movable glass panel and the fixed glass panel.

The rain channel may be formed along a rim portion of the fixed glass panel. The shape of the rain channel may have a U-shaped cross section shape with ends that extend to edges of the housing. The rain channel nay include an outer vertical portion, an inner vertical portion, and an opening for rain to enter, thereby exposing the rain channel between the movable glass panel and the fixed glass panel. In some eases, an opening length of the rain channel in the forward direction may be 120 mm or greater.

Subsequently the large and, exposed rain channel allows for much water flow into the channel. Although a purpose of the channel is to guide water away from the area between the glass panels, allowing a maximum amount of water to enter the water channel may make the channel ineffective over time. For example, a rain channel typically includes a weather strip formed as the U-shaped channel. Over time, the weather strip may wear allowing eater to eventually start to leak into the passenger compartment of a vehicle. These and other problems are addressed by the disclosure.

### SUMMARY

The present disclosure relates to a sunroof apparatus for an automotive vehicle, including at least one fixed glass panel having an outer rim, at least one movable glass panel having an outer rim, an area between the outer rim of the movable glass panel in the width direction of the vehicle and the fixed panel includes a rain channel. A solution provided by the present disclosure is to cover a majority of the rain channel with the fixed panel to reduce the rate of water flow into the rain channel.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic plan view of a sunroof apparatus for a vehicle according to an exemplary aspect of the disclosure; and

FIG. 2 is a partial view of a sunroof apparatus in the vicinity of an end in the width direction of a rain channel according to an exemplary aspect of the disclosure.

### DETAILED DESCRIPTION

The description set forth below in connection with the appended drawings is intended as a description of various aspects of the disclosed subject matter and is not necessarily intended to represent the only aspect(s). In certain instances, the description includes specific details for the purpose of providing an understanding of the disclosed subject matter. However, it will be apparent to those skilled in the art that aspects may be practiced without these specific details. In some instances, well-known structures and components may be shown in block diagram form in order to avoid obscuring the concepts of the disclosed subject matter.

Reference throughout the specification to “one aspect” or “an aspect” means that a particular feature, structure, characteristic, operation, or function described in connection with an aspect is included in at least one aspect of the disclosed subject matter. Thus, any appearance of the phrases “in one aspect” or “in an aspect” in the specification is not necessarily referring to the same aspect. Further, the particular features, structures, characteristics, operations, or functions may be combined in any suitable manner in one or more aspects. Further, it is intended that aspects of the disclosed subject matter can and do cover modifications and variations of the described aspects.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “upper,” “lower,” “front,” “rear,” “side,” “interior,” “exterior,” and the like that may be used herein, merely describe points of reference and do not necessarily limit aspects of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit aspects of the disclosed subject matter to any particular configuration or orientation.

Referring now to the drawings, wherein like reference numerals designate identical or corresponding parts throughout several views, the following description relates to a sunroof assembly for an automotive vehicle. Automotive vehicles may be provided with sunroof assemblies having a fixed panel and a movable panel with a weather strip in between to serve as a rain channel. The rain channel results in a noticeable gap between the movable panel and the fixed panel. Also, the weather strip may suffer from wear and tear, such that over time water leakage may occur. Disclosed are embodiments that provide a solution to this problem.

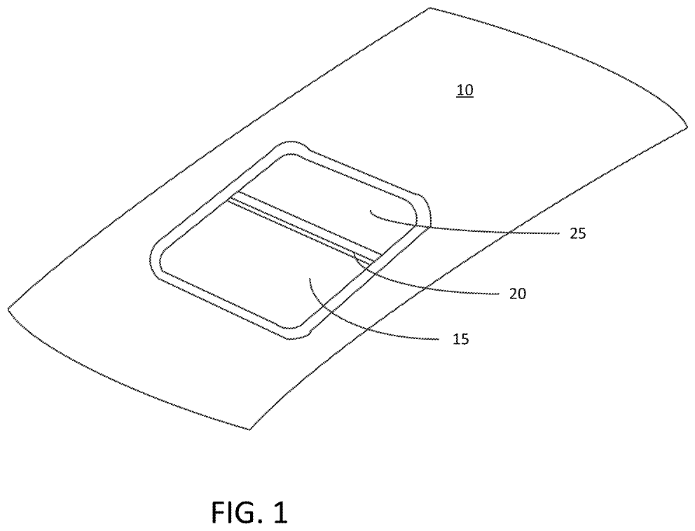

A sunroof apparatus of a vehicle roof 10 will be explained. Hereinafter, a front/rear direction refers to a forward/rearward direction relative to a traveling direction of the vehicle having the roof 10. A right/left direction or a width direction refers to a direction of the vehicle relative to the front of the vehicle. An upward/downward direction refers to a direction relative to ground below the vehicle. FIG. 1 is a schematic plan view of a sunroof apparatus for a vehicle according to an exemplary aspect of the disclosure. The sunroof apparatus includes a movable glass panel 15, a fixed glass panel 25 and a rain channel 20 between the two panels. The movable glass panel 15 can move to a closed position over an opening portion of the same size. Although the drawing shows a single fixed panel and a single movable panel, the sunroof apparatus may have more than one fixed panel and/or more than one movable panel. A movable panel may be in a forward position toward the front of the vehicle. However, the movable panel may be in a rearward position, or in a middle position of the sunroof apparatus. The movable panel is arranged to be lifted at an end that is adjacent to a fixed panel and slid over the fixed panel. The water channel may include a weather strip made of a rubber material that covers a metal reinforced channel structure.

The movable glass panel 15 and a fixed glass panel 25 are encased by a housing that surrounds the outer rim of each panel when the movable glass panel 15 is in a closed position. To open the sunroof, the movable glass panel 15 is tilted upward and is slid along a pair of rails to a position above the fixed glass panel 25. Rims of the movable glass panel 15 and the fixed glass panel 25 may be of a light metal, such as aluminum or stainless steel. The housing also may be of a light metal.

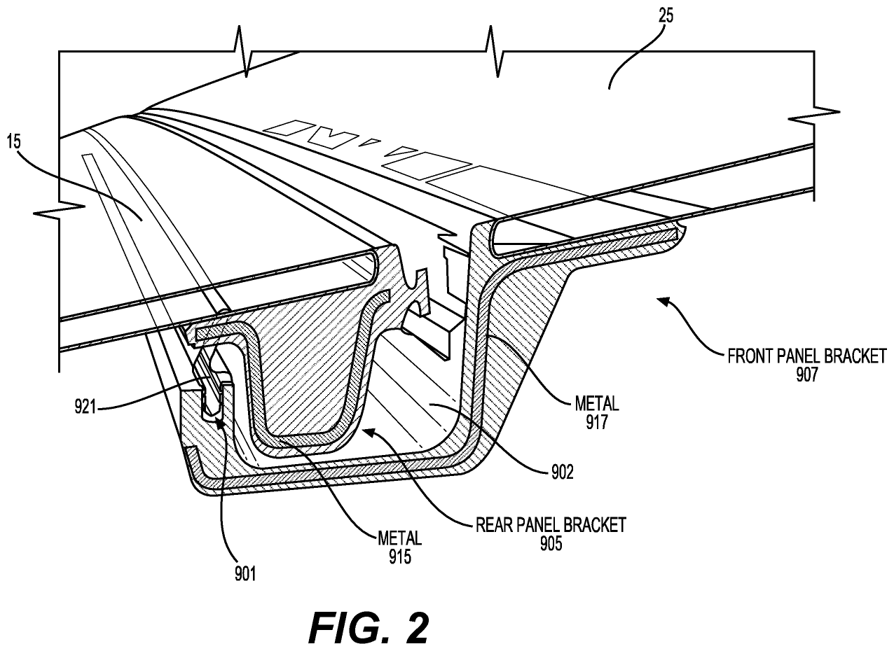

FIG. 2 is a partial view of a sunroof apparatus in the vicinity of a width direction end of a rain channel according, to an exemplary aspect of the disclosure. In the closed position, the movable glass panel 15 is separate from a fixed glass panel 25 by a space that is sufficient to allow movement of the movable panel 15. A rim portion of the movable glass panel 15 extends underneath the fixed glass panel 25 and forms a middle rain channel 902. In some embodiments, a majority of the rain channel 902 is formed underneath of the fixed glass panel 25 such that the fixed glass panel 25 covers a majority of an upper open portion of the rain channel 902 and spacing between the fixed glass panel 15 and the movable glass panel 15 corresponds to a remaining opening to the rain channel 902. In one embodiment, the majority of the upper open portion of the rain channel 902 that is covered by the fixed glass panel 25 is at least three-quarters of the open portion of the rain channel 902 in the forward-rearward direction.

In particular, the rim of the movable glass panel 15 at an edge that is adjacent to the fixed glass panel 25 may include a rain channel 902 having a U-shaped cross section in order to trap water. The U-shaped rain channel 902 has an edge-mounted vertical side that attached to the movable glass panel 15 and a second vertical side that is away from the edge-mounted vertical side in a rearward direction. The U-shaped rain channel 902 may be formed of a metal reinforcement 917 encased in a weather strip 921 of a rubber material. The second vertical side of the rain channel 902 is at least in the vicinity of the rim of the fixed glass panel 25. The edge of the rim of the movable glass panel 15 in the rearward direction may include a mounting channel, or recess 901, that forms a secondary seal for the middle rain channel 902. With this arrangement, an end portion of the weather strip 921 of the second vertical side may form a seal with the underside of the rim of the fixed glass panel 25 and prevent water from leaking into the vehicle cabin.

The fixed glass panel 25 may include an end bracket 905 that rests inside the middle rain channel 902 in the closed position. The end bracket 905 protrudes in a downward direction at the end of the rim of the fixed glass panel 25 in the forward direction. The end bracket 905 may be reinforced with a metal insert 915 having a U-shaped cross-section that fits within the U-shaped cross section of the rain channel 902. Because the middle rain channel 902 is underneath the fixed glass panel 25, the movable glass panel 15 and the fixed glass panel 25 have a one-piece appearance. A spacing area, between the fixed glass panel 25 and the movable glass panel 15 allows water to enter into the spacing area. However, the close proximity of the movable glass panel 15 to the fixed glass panel 25 in the closed position serves to limit the rate of flow of water into the rain channel 902.

In addition, the movable glass panel 205 and the fixed glass panel 207 are spaced apart from each other so that the movable glass panel 205 is able to freely move into an open position and back to a closed position. In one embodiment, the weather strip 921 may be arranged to line the space between the movable glass panel 205 and the fixed glass panel 207. With this arrangement, even if the weather strip 921 allows some leakage, the small amount of water leakage will be trapped by the rain channel 902.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components.

The foregoing discussion describes merely exemplary embodiments of the present disclosure. As will be understood by those skilled in the art, the present disclosure may be embodied in other specific forms without departing from the spirit or essential characteristics thereof. Accordingly, the disclosure is intended to be illustrative, but not limiting of the scope of the disclosure, as well as the claims. The disclosure, including any readily discernible variants of the teachings herein, defines in part, the scope of the foregoing claim terminology such that no inventive subject matter is dedicated to the public.

1. A sunroof apparatus for an automotive vehicle, comprising:
at least one fixed glass panel having a first outer rim;
at least one movable glass panel having a second outer rim;
a portion of the first outer rim of the fixed glass panel in the forward direction of the vehicle is adjacent to the movable panel and includes a water channel; and
a majority of the water channel is formed underneath of the movable glass panel such that the movable glass panel covers a majority of an upper open portion of the water channel and spacing between the fixed glass panel and the movable glass panel corresponds to a remaining opening to the water channel.

2. The sunroof apparatus of claim 1, wherein the water channel is an extension of the fixed glass panel.

3. The sunroof apparatus of claim 1, further including a weather strip formed over a surface of the rain channel such that an edge of the water channel and the movable glass panel form a seal.

4. The sunroof apparatus of claim 3, wherein another edge of the weather strip is between the fixed glass panel and the movable glass panel in the forward direction.

5. The sunroof apparatus of claim 1, wherein the majority of the upper open portion of the water channel that is covered by the movable glass panel is at least three-quarters of the open portion of the water channel in the forward-rearward direction.
